(19) United States
(12) Patent Application Publication
(10) Pub. No.: US 2025/0342213 A1
(43) Pub. Date: Nov. 6, 2025

(54) Document Correlation Systems And Methods

(71) Applicants: Barak Tsivkin, Newton Center, MA (US); Anthony P Macciola, Lake Forest, CA (US)

(72) Inventors: Barak Tsivkin, Newton Center, MA (US); Anthony P Macciola, Lake Forest, CA (US)

(21) Appl. No.: 19/186,495

(22) Filed: Apr. 22, 2025

Related U.S. Application Data
(60) Provisional application No. 63/556,456, filed on Feb. 22, 2024.

(51) Int. Cl. G06F 16/93; G06F 40/12

(52) U.S. Cl. CPC G06F 16/93; G06F 40/12

(57) ABSTRACT

Document correlation systems and methods are provided that comprise determining when different types of documents in a batch of documents begin and end. The document correlation systems and methods use patch code documents and a machine learning model to train on a data set until patch code documents are no longer needed.

### CROSS-REFERENCE TO RELATED APPLICATIONS

This application claims the benefit of U.S. Provisional Application Ser. No. 63/556,456, filed on Feb. 22, 2024, which is hereby incorporated by reference herein in its entirety.

### FIELD OF THE INVENTION

The invention relates to document correlation separation systems and methods relating to machine learning.

### BACKGROUND OF THE INVENTION

Machine learning typically requires manual labeling of the documents that are being analyzed. This is normally done by the following:

Gather training documents that represent the types of documents one is likely to encounter;

Manually label the documents by identifying the documents transitions;

Build the machine learning model;

Run the model against test documents and measure the accuracy and tolerance of the document separation results.

Repeat the process until able to achieve the desired fidelity; and

Publish the model and use it in production.

This process of document correlation models is neither quick nor easy, and it requires significant human intervention. The training review and model updating process generally requires coding expertise. New and improved systems and methods of creating and updating document correlation models are therefore needed.

### SUMMARY OF THE INVENTION

The present invention is designed to aid in the fine-tuning of document correlation separation models (both visual and language based). The present subject matter provides high fidelity out-of-the-box models that require no fine-tuning or refinement before use that can be improved by adjusting the baseline models with real-world customer data.

In certain preferred embodiments, document correlation systems and methods are provided that comprise determining when different types of documents in a batch of documents begin and end. The document correlation systems and methods use patch code documents and a machine learning model to train on a data set until patch code documents are no longer needed.

In certain preferred embodiments, systems and methods of document correlation for machine learning, which are applied to document capture processes, are provided. The systems and methods comprise (a) loading into a scanner a batch of documents (e.g., a training set of multi-page documents with patch code pages), the batch of documents comprising (i) multiple documents, each document having a document boundary, and (ii) multiple patch-code pages, each patch-code page corresponding to one of the documents. They also comprise (b) scanning the batch of documents to create a data set, the data set comprising information for (i) each document in a document file, each document file having document boundary data, each document file being in a TIFF or PDF format, and (ii) each patch-code page, each patch-code page corresponding to one of the document files, and each patch-code page having physical document boundary information (e.g., physical separation information or results) for each document file. They also comprise (c) applying a baseline correlation model to the data set of information to make separation predictions (e.g., digital separation information or results) concerning the document boundaries without reference to the physical document boundary information provided by the patch-code pages; (d) comparing the separation predictions to the patch-code provided physical document boundary information (e.g., compare the physical separation information or results with the digital separation information or results) to identify any inaccuracies, such as in the separation predictions; (e) updating the correlation model to reflect any corrections to the separation predictions based on the patch-code physical document boundary information comparison (e.g., choose to use the physical results or the digital results, corrected or otherwise) and generating associated F1 Score, Precision and Recall stats; (f) flagging any corrections to the separation predictions for human review, updating the correlation model to reflect any corrections made by the human review, and generating F1 Score, Precision and Recall stats; and (g) repeating any of (b) through (f) as necessary until the steps are applied to the complete batch of documents.

These systems and methods can also comprise auto-generating and inserting digital patch-code separator pages into the data set of information as the document boundaries are determined, and/or auto-generating and embedding Code 39 barcodes in the digital patch-code separator pages.

These systems and methods can also comprise deploying them via a transparent plug-in that allows them to remain backward compatible with existing product capture processes. In other embodiments, the systems and methods are integrated into a document capture process that analyzes new incoming scanned documents. In addition, in some embodiments, the F1 Score, Precision and Recall stats are analyzed to determine (i) when to publish the correlation model and apply it to the document capture process, and (ii) when to retire any further use of patch-code pages having physical document boundary information.

In other preferred embodiments, systems and methods of document correlation for machine learning that are integrated into an existing document capture process are provided. These systems and methods can comprise (a) providing for the integrating of steps into an existing document capture process; (b) loading into a scanner a batch of documents, the batch of documents comprising (i) multiple documents, each document having a document boundary, and (ii) multiple patch-code pages, each patch-code page corresponding to one of the documents; (c) scanning the batch of documents to create a data set, the data set comprising information for (i) each document in a document file, each document file having document boundary data, each document file being in a TIFF or PDF format, and (ii) each patch-code page, each patch-code page corresponding to one of the document files, and each patch-code page having physical document boundary information for one of the document files; (d) applying a correlation model to the data set of information to make separation predictions concerning the document boundaries without reference to the physical document boundary information provided by the patch-code pages; (e) comparing the separation predictions to the patch-code provided physical document boundary information to identify any inaccuracies in the separation predictions; (f) updating the correlation model to reflect any corrections to the separation predictions based on the patch-code physical document boundary information comparison and generating associated F1 Score, Precision and Recall stats; (g) flagging any corrections to the separation predictions for human review, updating the correlation model to reflect any corrections made by the human review, and generating F1 Score, Precision and Recall stats; and (h) repeating any of (c) through (g) as necessary until the steps are applied to the complete batch of documents.

These preferred systems and methods can also comprise auto-generating and inserting digital patch-code separator pages into the data set of information as the document boundaries are determined and/or auto-generating and embedding Code 39 barcodes in the digital patch-code separator pages. Certain of these embodiments can also be deployed via a transparent plug-in that allows it to remain backwards compatible with existing product capture processes. Certain of these embodiments are integrated into a document capture process that analyzes new incoming scanned documents. In certain of these embodiments, the F1 Score, Precision and Recall stats are analyzed to determine (i) when to publish the correlation model and apply it to a document capture process, and (ii) when to retire any further use of patch-code pages having physical document boundary information.

In other preferred systems and methods of this invention, document correlation systems and their methods are provided. They comprise (a) one or more processors, the one or more processors coupled to the output of a document scanner that is capable of scanning a batch of documents to create a data set of information concerning the batch of documents; (b) a memory coupled to the one or more processors, the memory storing non-transitory executable instructions to cause the one or more processors to perform actions to the data set of information, the data set of information comprising information for (i) each document in a document file, each document file having document boundary data, each document file being in a TIFF or PDF format, and (ii) each patch-code page, each patch-code page corresponding to one of the document files, and each patch-code page having physical document boundary information for one of the document files.

In these embodiments, the processors can perform a number of actions that comprise (i) application of a correlation model to the data set of information to make separation predictions concerning the document boundaries without reference to the physical document boundary information provided by the patch-code pages; (ii) comparisons of the separation predictions to the patch-code provided physical document boundary information to identify any inaccuracies in the separation predictions; (iii) updating of the correlation model to reflect any corrections to the separation predictions based on the patch-code physical document boundary information comparison and generating associated F1 Score, Precision and Recall stats; (iv) flagging of any corrections to the separation predictions for human review, updating the correlation model to reflect any corrections made by the human review, and generating F1 Score, Precision and Recall stats; and (v) repeating any of (i) through (iv) as necessary until they are applied to the complete batch of documents.

In these embodiments, the one or more processors' actions can further comprise auto-generating and inserting digital patch-code separator pages into the data set of information as the document boundaries are determined. They can also comprise auto-generating and embedding Code 39 barcodes in the digital patch-code separator pages. Certain of these embodiments can be deployed via a transparent plug-in that allows it to remain backwards compatible with existing product capture processes. Some of them can also be integrated into a document capture process that analyzes new incoming scanned documents. Some of the actions of the processors can also include, in some embodiments, analysis of the F1 Score, Precision and Recall stats are analyzed to determine (i) when to publish the correlation model and apply it to the document capture process, and (ii) when to retire any further use of patch-code pages having physical document boundary information.

Some embodiments of this invention can also provide for the updating of document correlation models. This can comprise (a) loading into a scanner a batch of documents, the batch of documents comprising (i) multiple documents, each document having a document boundary, and (ii) multiple patch-code pages, each patch-code page corresponding to one of the documents; (b) scanning the batch of documents to create a data set, the data set comprising information for (i) each document in a document file, each document file having document boundary data, each document file being in a TIFF or PDF format, and (ii) each patch-code page corresponding to one of the document files, and each patch-code page having physical document boundary information for one of the document files; (c) applying a baseline correlation model to the data set of information to make separation predictions concerning the document boundaries without reference to the physical document boundary information provided by the patch-code pages; (d) comparing the separation predictions to the patch-code provided physical document boundary information to identify any inaccuracies in the separation predictions; (e) updating the correlation model to reflect any corrections to the separation predictions based on the patch-code physical document boundary information comparison and generating associated F1 Score, Precision and Recall stats; (f) flagging any corrections to the separation predictions for human review, updating the correlation model to reflect any corrections made by the human review, and generating F1 Score, Precision and Recall stats; and (g) repeating any of (b) through (e) as necessary until the steps are applied to the complete batch of documents.

In certain preferred embodiments of this invention, systems and methods are provided that perform document correlation for machine learning applied to document capture processes. These embodiments can comprise (a) loading into a scanner a batch of documents, the batch of documents comprising (i) multiple documents, each document having a document boundary, and (ii) multiple patch-code pages, each patch-code page corresponding to one of the documents; (b) scanning the batch of documents to create a data set, the data set comprising information for (i) each document in a document file, each document file having document boundary data, each document file being in a TIFF or PDF format, and (ii) each patch-code page, each patch-code page corresponding to one of the document files, and each patch-code page having physical document boundary information for each document file; (c) applying a baseline correlation model to the data set of information to make separation predictions concerning the document boundaries without reference to the physical document boundary information provided by the patch-code pages; (d) comparing the separation predictions to the patch-code provided physical document boundary information to identify any inaccuracies in the separation predictions; (e) updating the correlation model to reflect any corrections to the separation predictions based on the patch-code physical document boundary information comparison and generating associated F1 Score, Precision and Recall stats; (f) flagging any corrections to the separation predictions for human review, updating the correlation model to reflect any corrections made by the human review, and generating F1 Score, Precision and Recall stats; and (g) repeating any of (b) through (f) as necessary until the steps are applied to the complete batch of documents.

The present subject matter makes the process of fine-tuning document correlation models quick and easy, with minimal human intervention. The training review and model updating process is provided as a no-code experience that any business user can quickly learn and leverage.

In the description set forth herein, the drawings are intended to illustrate major features of exemplary embodiments in a diagrammatic manner. The drawings are not intended to depict every feature of every implementation.

In the description set forth herein, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

### BRIEF DESCRIPTION OF DRAWINGS

FIG. 1 shows a diagram of the machine learning process from prior art.

FIG. 2 shows a diagram of the machine learning process for the document boundary or separation analyzer and correlation model builder.

FIG. 3 shows patch code page 1.

FIG. 4 shows patch code page 2.

FIG. 5 shows patch code page 3.

FIG. 6 shows patch code page 4.

FIG. 7 shows patch code page T.

### DETAILED DESCRIPTION OF THE INVENTION

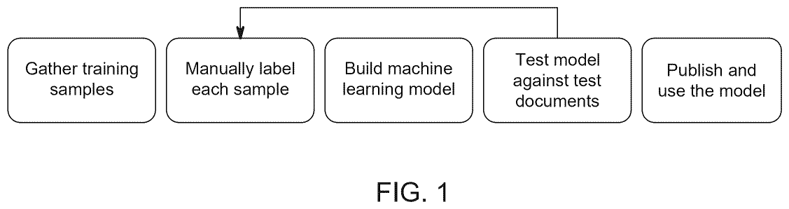

The present invention is based on the concept of using real-world patch-code separator pages to train a document correlation system separation and classification model, enabling human review to make any needed corrections before building the final machine learning model. It has significant advantages over prior art systems and processes (e.g., FIG. 1).

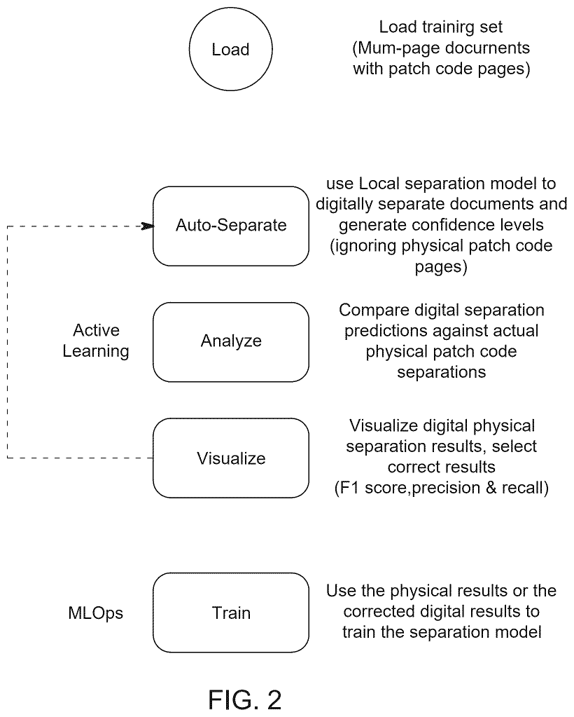

The present subject matter in certain preferred embodiments (e.g., FIG. 2) is broken down into steps, actions and/or processes.

For example, FIG. 2 shows systems and methods of this invention. A training set of documents (or data) is first loaded. The training set in some embodiments comprises multi-page documents separated from one another with patch-code pages. Active learning of the artificial intelligence (e.g., in a machine learning module, in a correlation model, a local separation model) is implemented by auto-separation of the documents (or data), analysis of the documents (or data), and visualization of the results with identification and selection of correct and incorrect results. The artificial intelligence is then trained with the selected results.

This active learning in some embodiments can use auto-separation of the documents with a local separation model to digitally separate documents and generate confidence levels, ignoring the physical patch code pages.

The active learning in these embodiments can then include analysis comprising a comparison of the digital separation predictions from the model against the actual physical patch code separations. Next can come visualization of the digital separation results (e.g., from the model) versus the physical separation results (e.g., from the patch code separations) and selection of the correct results, providing a F1 score and/or Precision and Recall stats.

The MLOps or machine learning operations can be applied to train the artificial intelligence using the physical results (e.g., from the patch code separations) or the corrected digital results (e.g., from the model) to train the model further.

These steps in certain embodiments may also comprise the following.

1. The user can start the process one of two ways:

a. Create a project by loading a set of multi-page TIFF or PDF files containing patch-code pages that were manually inserted into the batch prior to scanning for the purpose of physically establishing document boundaries (preferably 50 to 100 sample training documents).

b. Integrate the present subject matter into the document correlation system being used, allowing the document correlation system based on the current digital separation models to analyze the incoming scanned documents.

2. In either step (1a or 1b) the present subject matter will Initially ignore any encountered patch-code pages and will use the baseline correlation models of these embodiments to determine digital document boundaries.

3. Once a complete pass has been made through the batch, the present subject matter then compares digital separation predictions against the actual (physical) patch-code directed document boundaries.

4. The present subject matter can be configured to assume physical document separation is considered ground truth. In this mode, the document separation analyzer and model builder will update the correlation model fine-tuning process to reflect any corrections to the digital page boundary predictions based on physical document boundaries and generate associated F1 Score, Precision and Recall stats, for review and consideration.

5. The document separation analyzer and model builder can also be configured to flag physical vs. digital page boundary mis-assignments to allow a human in the loop review process the discrepancies and determine which boundary assignment to use for model fine-tuning (realizing that physical human directed document separation typically incurs a 3%-4% error rate). In this mode, the present subject matter will update the correlation model fine-tuning process to reflect any corrections made by the operator and generate F1 Score, Precision and Recall stats for review and consideration.

6. If using 1a, the user then repeats steps 2 through 5 for each sample training document until complete.

7. If using 1b, the operator can review F1 Score, Precision and Recall results to determine when to publish an auto fine-tuned correlation model to production and when to retire physical document separation.

8. The present subject matter will provide an added option for auto-generating (inserting) digital patch-code separator pages into a batch file as it determines document boundaries. The document separation analyzer will also provide the option of embedding Code 39 barcodes on the digitally generated patch code separator pages. This allows the present subject matter to be deployed as a correlation system in the field as a transparent plug-in and allow it to remain backwards compatible with existing product capture deployments.

Using physical patch-code pages to train the correlation models allows production capture deployments to continue operations as normal and allows the present subject matter to silently watch and learn. Once the digital document boundary prediction matches or surpasses the physical results, physical separation can be eliminated, resulting in dramatic savings in labor, time, materials, and facility costs. The present subject matter's ability to automate the fine-tuning of correlation models will result in increased document separation fidelity and consistency.

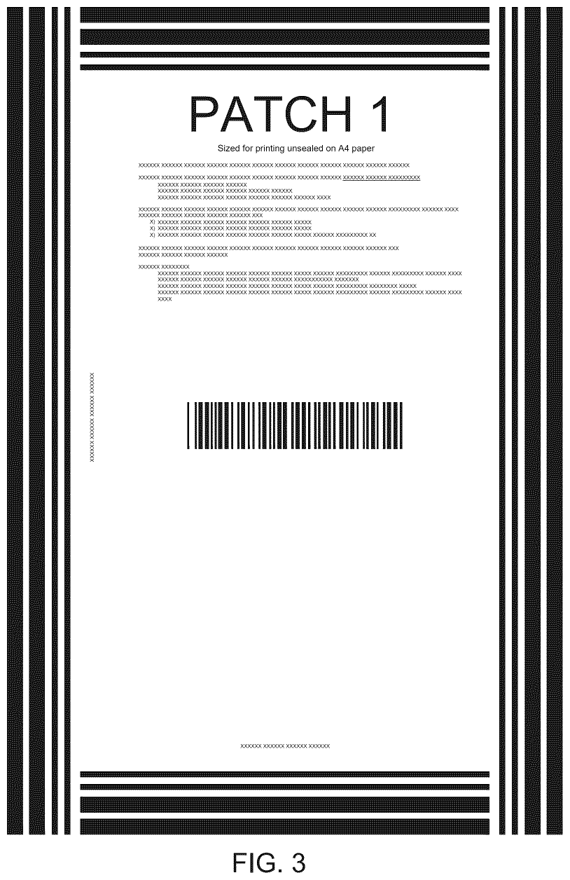

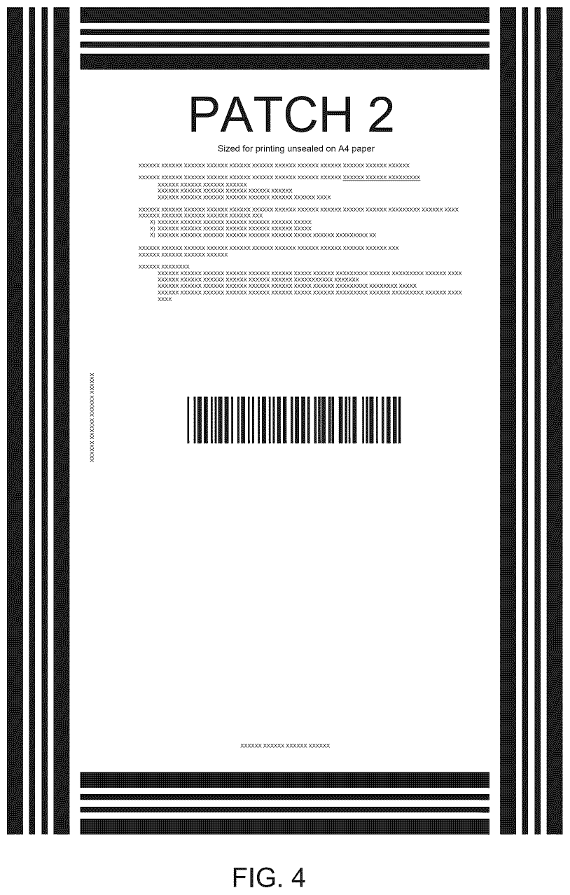

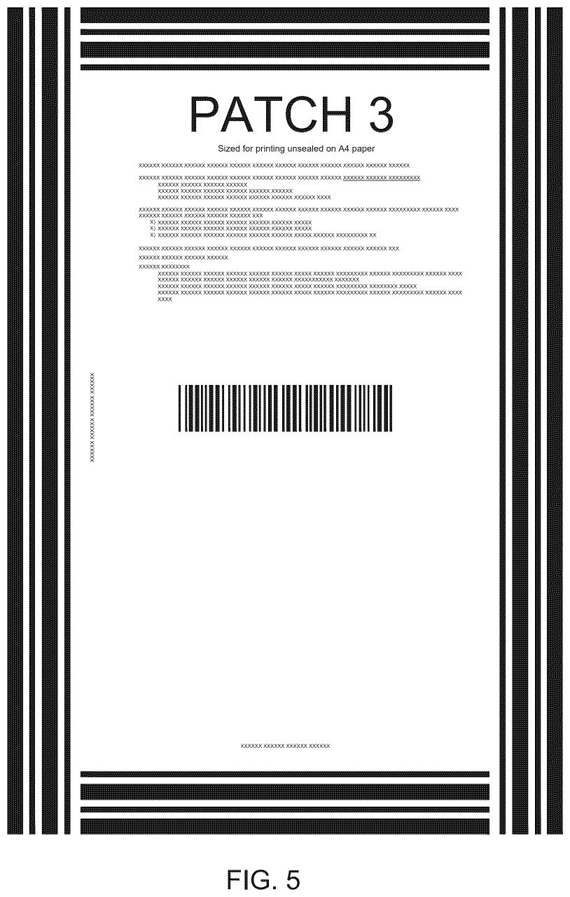

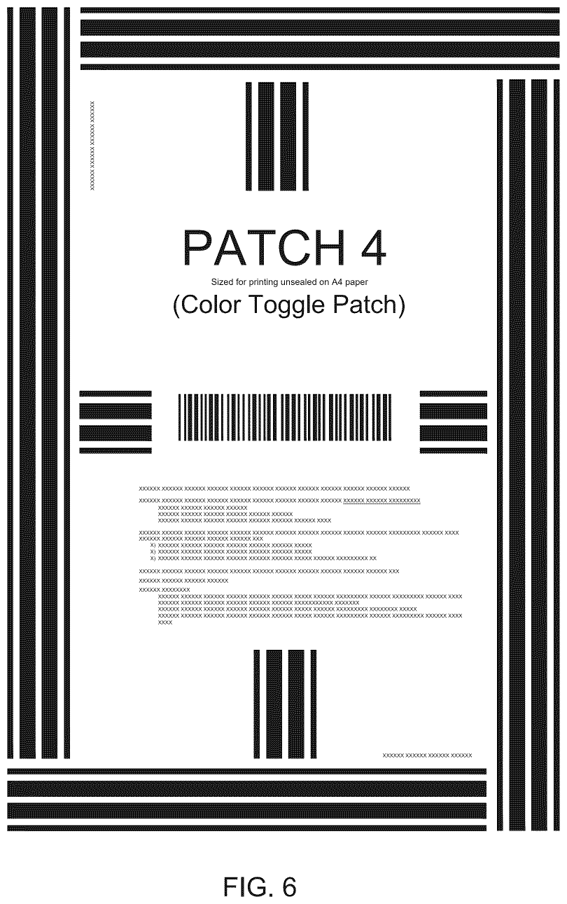

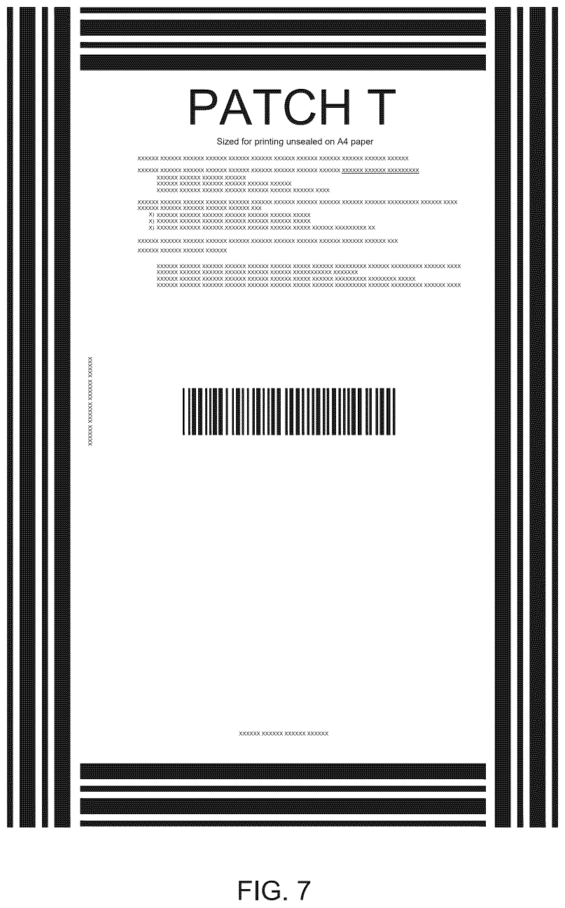

A patch code is a pattern of parallel, alternating black bars and spaces (a barcode) that is printed on a document. FIGS. 3-7 provide illustrative examples. When scanning the document, the patch code can be recognized and acted upon. The patch code may be recognized by the scanner itself (more usually in the top-end expensive scanners) or by the scanning or processing software or with a TWAIN or ISIS driver.

Exactly what action is taken depends upon the design of any given system. A patch code is printed in a certain position, usually near the leading edge (feed-edge) of the document. This will vary depending upon the model of scanner used, and the orientation of the page.

For this reason, patch codes are often printed on all four edges of the page. Some scanners (such as the Kodak i800) require the patch code to be printed parallel to the feed-edge, other scanners (such as the Kodak i5000) require the patch code to be perpendicular (at right angles) to the feed-edge.

A typical use of a patch code is to distinguish where one document ends and another begins when a pile of documents is loaded into the sheet feeder (ADF) of a document scanner. The patch code was originally created by Kodak to signal document processing

applications while reading large documents. The different codes will signal certain events such as a page/section break or a change from single sided to duplex scanning. Six distinct barcode patterns (Patch 1, 2, 3, 4, 6 and T) were defined. A common use now is to use the Patch T code or the Patch 2 code as a Page (document) separator.

Note that no data is encoded in a patch code in preferred embodiments. Similarly, although there may be 4 identical patch codes on a page (one in each orientation), patch code readers (hardware or software) would only ever return one in preferred embodiments. Patch Codes are wide/narrow 1D barcodes (as are Code 39 barcodes, for example). Patch Codes are best printed in black on white paper, however one can use light pastel colored paper to make patch pages more visible to operators.

It is also possible to add conventional barcodes (typically Code 39) to a sheet to, for example, indicate the document type. It is possible to incorporate a patch code into a form (typically a Patch 2 code on the first page of the form), to indicate a new file should be started for each form.

The exact action taken on recognizing a patch code will depend upon the system and software used and may be configurable in a given application.

Typically patch Type 2 is used for Document Separation, Type 3 for Batch Separation and Type T can be used for either Document or Batch Separation. Patch types 1, 4 and 6 are not used for document separation but to enable other features such as color or multi-feed detection. Patch code T is often used as a separator page between different documents when scanning.

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

We claim:

1. A method of document correlation for machine learning applied to a document capture process, the method comprising:
(a) loading into a scanner a batch of documents, the batch of documents comprising (i) multiple documents, each document having a document boundary, and (ii) multiple patch-code pages, each patch-code page corresponding to one of the documents;
(b) scanning the batch of documents to create a data set, the data set comprising information for (i) each document in a document file, each document file having document boundary data, each document file being in a TIFF or PDF format, and (ii) each patch-code page, each patch-code page corresponding to one of the document files, and each patch-code page having physical document boundary information for each document file;
(c) applying a baseline correlation model to the data set of information to make separation predictions concerning the document boundaries without reference to the physical document boundary information provided by the patch-code pages;
(d) comparing the separation predictions to the patch-code provided physical document boundary information to identify any inaccuracies in the separation predictions;
(e) updating the correlation model to reflect any corrections to the separation predictions based on the patch-code physical document boundary information comparison and generating associated F1 Score, Precision and Recall stats;
(f) flagging any corrections to the separation predictions for human review, updating the correlation model to reflect any corrections made by the human review, and generating F1 Score, Precision and Recall stats; and
(g) repeating any of (b) through (f) as necessary until the steps are applied to the complete batch of documents.

2. The method of claim 1, further comprising auto-generating and inserting digital patch-code separator pages into the data set of information as the document boundaries are determined.

3. The method of claim 2, further comprising auto-generating and embedding Code 39 barcodes in the digital patch-code separator pages.

4. The method of claim 1, wherein the method is deployed via a transparent plug-in that allows it to remain backwards compatible with existing product capture processes.

5. The method of claim 1, wherein the method is integrated into a document capture process that analyzes new incoming scanned documents.

6. The method of claim 1, wherein the F1 Score, Precision and Recall stats are analyzed to determine (i) when to publish the correlation model and apply it to the document capture process, and (ii) when to retire any further use of patch-code pages having physical document boundary information.

7. A method of document correlation for machine learning integrated into an existing document capture process, the method comprising:
(a) providing for the integrating of any of the steps (b) through (f) as necessary into the existing document capture process;
(b) loading into a scanner a batch of documents, the batch of documents comprising (i) multiple documents, each document having a document boundary, and (ii) multiple patch-code pages, each patch-code page corresponding to one of the documents;
(c) scanning the batch of documents to create a data set, the data set comprising information for (i) each document in a document file, each document file having document boundary data, each document file being in a TIFF or PDF format, and (ii) each patch-code page, each patch-code page corresponding to one of the document files, and each patch-code page having physical document boundary information for one of the document files;
(d) applying a correlation model to the data set of information to make separation predictions concerning the document boundaries without reference to the physical document boundary information provided by the patch-code pages;
(e) comparing the separation predictions to the patch-code provided physical document boundary information to identify any inaccuracies in the separation predictions;
(f) updating the correlation model to reflect any corrections to the separation predictions based on the patch-code physical document boundary information comparison and generating associated F1 Score, Precision and Recall stats;
(g) flagging any corrections to the separation predictions for human review, updating the correlation model to reflect any corrections made by the human review, and generating F1 Score, Precision and Recall stats; and
(h) repeating any of (c) through (g) as necessary until the steps are applied to the complete batch of documents.

8. The method of claim 7, further comprising auto-generating and inserting digital patch-code separator pages into the data set of information as the document boundaries are determined.

9. The method of claim 8, further comprising auto-generating and embedding Code 39 barcodes in the digital patch-code separator pages.

10. The method of claim 7, wherein the method is deployed via a transparent plug-in that allows it to remain backwards compatible with existing product capture processes.

11. The method of claim 7, wherein the method is integrated into a document capture process that analyzes new incoming scanned documents.

12. The method of claim 7, wherein the F1 Score, Precision and Recall stats are analyzed to determine (i) when to publish the correlation model and apply it to a document capture process, and (ii) when to retire any further use of patch-code pages having physical document boundary information.

13. A document correlation system, the system comprising:
(a) one or more processors, the one or more processors coupled to the output of a document scanner that is capable of scanning a batch of documents to create a data set of information concerning the batch of documents;
(b) a memory coupled to the one or more processors, the memory storing non-transitory executable instructions to cause the one or more processors to perform actions to the data set of information, the data set of information comprising information for (i) each document in a document file, each document file having document boundary data, each document file being in a TIFF or PDF format, and (ii) each patch-code page, each patch-code page corresponding to one of the document files, and each patch-code page having physical document boundary information for one of the document files, wherein the actions comprise:
i. application of a correlation model to the data set of information to make separation predictions concerning the document boundaries without reference to the physical document boundary information provided by the patch-code pages;
ii. comparisons of the separation predictions to the patch-code provided physical document boundary information to identify any inaccuracies in the separation predictions;
iii. updating of the correlation model to reflect any corrections to the separation predictions based on the patch-code physical document boundary information comparison and generating associated F1 Score, Precision and Recall stats;
iv. flagging of any corrections to the separation predictions for human review, updating the correlation model to reflect any corrections made by the human review, and generating F1 Score, Precision and Recall stats; and
v. repeating any of (i) through (iv) as necessary until they are applied to the complete batch of documents.

14. The system of claim 13, wherein the actions further comprise auto-generating and inserting digital patch-code separator pages into the data set of information as the document boundaries are determined.

15. The system of claim 14, wherein the actions further comprise auto-generating and embedding Code 39 barcodes in the digital patch-code separator pages.

16. The system of claim 13, wherein the system is deployed via a transparent plug-in that allows it to remain backwards compatible with existing product capture processes.

17. The system of claim 13, wherein the system is integrated into a document capture process that analyzes new incoming scanned documents.

18. The system of claim 13, wherein the actions further comprise analysis of the F1 Score, Precision and Recall stats are analyzed to determine (i) when to publish the correlation model and apply it to the document capture process, and (ii) when to retire any further use of patch-code pages having physical document boundary information.

19. A method for updating a document correlation model, the method comprising:
(a) loading into a scanner a batch of documents, the batch of documents comprising (i) multiple documents, each document having a document boundary, and (ii) multiple patch-code pages, each patch-code page corresponding to one of the documents;
(b) scanning the batch of documents to create a data set, the data set comprising information for (i) each document in a document file, each document file having document boundary data, each document file being in a TIFF or PDF format, and (ii) each patch-code page, each patch-code page corresponding to one of the document files, and each patch-code page having physical document boundary information for one of the document files;
(c) applying a baseline correlation model to the data set of information to make separation predictions concerning the document boundaries without reference to the physical document boundary information provided by the patch-code pages;
(d) comparing the separation predictions to the patch-code provided physical document boundary information to identify any inaccuracies in the separation predictions;
(e) updating the correlation model to reflect any corrections to the separation predictions based on the patch-code physical document boundary information comparison and generating associated F1 Score, Precision and Recall stats;
(f) flagging any corrections to the separation predictions for human review, updating the correlation model to reflect any corrections made by the human review, and generating F1 Score, Precision and Recall stats; and
(g) repeating any of (b) through (f) as necessary until the steps are applied to the complete batch of documents.

20. A method of document correlation for machine learning applied to a document capture process, the method comprising:
(a) loading into a scanner a batch of documents, the batch of documents comprising (i) multiple documents, each document having a document boundary, and (ii) multiple patch-code pages, each patch-code page corresponding to one of the documents;
(b) scanning the batch of documents to create a data set, the data set comprising information for (i) each document in a document file, each document file having document boundary data, each document file being in a TIFF or PDF format, and (ii) each patch-code page, each patch-code page corresponding to one of the document files, and each patch-code page having physical document boundary information for each document file;
(c) applying a baseline correlation model to the data set of information to make separation predictions concerning the document boundaries without reference to the physical document boundary information provided by the patch-code pages;
(d) comparing the separation predictions to the patch-code provided physical document boundary information to identify any inaccuracies in the separation predictions;
(e) updating the correlation model to reflect any corrections to the separation predictions based on the patch-code physical document boundary information comparison and generating associated F1 Score, Precision and Recall stats;
(f) flagging any corrections to the separation predictions for human review, updating the correlation model to reflect any corrections made by the human review, and generating F1 Score, Precision and Recall stats; and
(g) repeating any of (b) through (f) as necessary until the steps are applied to the complete batch of documents.
